(19) United States
(12) Patent Application Publication
(10) Pub. No.: US 2008/0086532 A1
(43) Pub. Date: Apr. 10, 2008

(54) Method for the Verification of Electronic Message Delivery and for the Collection of Data Related to Electronic Messages Sent with False Origination Addresses

(76) Inventor: Brian Cunningham, Cambridge, MA (US)

Correspondence Address: GOODMAN, ALLEN & FILETTI PLLC, 4501 HIGHWOODS PARKWAY, SUITE 210, GLEN ALLEN, VA, 23060, US

(21) Appl. No.: 11/576,557

(22) PCT Filed: Oct. 4, 2005
(86) PCT No.: PCT/US05/35676

§ 371 Date: Apr. 3, 2007

Related U.S. Application Data
(60) Provisional application No. 60/616,191, filed on Oct. 4, 2004.

(51) Int. Cl. G06F 15/173

(52) U.S. Cl. 709/206

(57) ABSTRACT

Upon receipt of an electronic message purported to have been sent by a sending device a receiving device transmits a confirmation request to the sending device requesting that the sending device confirm or deny that it originated the message. If the sending device replies confirming that it originated the message, the sending device prepares a data record indicating that the message was delivered. If the sending device replies denying that it originated the message, it requests data from the receiving device related to the message. Upon receipt of a reply denying that the sending device originated the message and requesting data related to the message, the receiving device transmits data related to the message to the sending device.

### TECHNICAL FIELD

The present invention relates to a method for verifying the delivery of electronic messages by recording data related to the response to a request for authentication for such message when the response to the authentication request from a recipient is in the affirmative and a method for collecting data related to electronic messages sent with false origination addresses by requesting, receiving and storing data related to such messages when the response to an authentication request from a recipient is in the negative.

### BACKGROUND ART

Electronic communication is an essential tool in facilitating both business and personal communication. One form of electronic messaging, email, offers several advantages over traditional forms of communication. Email allows for the almost instantaneous exchange of information, it allows for the transmission of multiple messages at very little cost and it permits the transfer of large data files from one sender to another user. Nonetheless, the inherent nature of email gives rise to certain disadvantages. Most notable, and a topic of critical concern, is the increasing proliferation of unwanted and unsolicited email or “Spam.”

Spam is unsolicited email that is typically transmitted to an extremely large number of email recipients. Spam is the electronic equivalent to “junk mail” received by traditional mail service. Generally, a Spam email is a commercial advertisement attempting to sell a product or service. Spam typically directs the recipient to take some action in order to purchase the product or service being advertised. This may be in the form of offering a phone number or a hyperlink in the text of the spam message which, when utilized by the recipient will place the recipient in contact with the seller of the goods or services. Spam is often, although not exclusively, utilized by entities marketing products or services outside the norm of traditional retailers and service providers. Some Spam messages contain information or graphics unsuitable for email users, particularly those who are children. However, Spam offers tremendous marketing benefits as it allows a retailer, marketer, or other sender to reach an incredibly large audience with a minimal economic expenditure.

Unfortunately, this benefit to the sender of Spam comes at a considerable cost to the unwilling recipients of Spam messages. Spamming costs companies millions of dollars in congested servers, expenses incurred employing measures to block the Spam email, and lost productivity due to email recipients having to wade through large amounts of Spam solicitations in order to find desired email. Further, Spam email provides an ideal medium for computer hackers to infect users' systems through the introduction of computer viruses and other malicious code.

Persons who desire to send Spam email are able to obtain email lists in a variety of ways. For example, email lists can be compiled from email addresses appearing on existing emails received by the sender or from users who provide their email address during electronic transactions. Additionally, lists of addresses are often compiled by third parties and sold in the same manner that traditional address lists have been sold.

According to one estimate, as of January 2004, Spam email constituted as much as 60% of all email traffic on the Internet (“Microsoft Sets Its Sights on Defeating Spam,” National Public Radio, Morning Edition, Feb. 2, 2004). As Spam has become more plentiful, there has arisen a great demand for an effective and efficient method which will detect and block delivery of these unsolicited messages.

Spam email, like all email, originates from a Sending Email System. All electronic messages, including Spam email messages, contain various data elements in a header, an envelope or another designated portion of the electronic message that facilitate transfer of the message. These include, most especially, the addresses of the intended recipients of the message, the address of the originator of the message and the date and time when the message was prepared. For example, under Internet standard RFC 2821, “Simple Mail Transfer Protocol,” the message envelope of an email contains various data elements including an originator address and one or more recipient addresses. Similarly, under standard RFC 2822, “Internet Message Format” an internet message header for an email must contain an origination date and an originator address and typically includes a destination address field.

An email address, whether an originator or a recipient address, typically takes the form of “user@domain name.” For either originator or recipient addresses, the domain name portion of the email address identifies the host system to which or from which email is sent or received. The “user” portion of the address identifies the specified user and is assigned by the host system which, in the case of an originator address, transmits emails prepared by the specified user or, in the case of a recipient address, receives email messages for the specified user.

A host system sending an email transfers email to an intended recipient by referencing the Domain Name System (“DNS”). When the sending host system receives a prepared email message, it first identifies the domain name for each of the intended recipients. Through processes well known to those schooled in the art, the sending host system then utilizes the Domain Name System (“DNS”) to determine the Internet Protocol (IP) address of the host system associated with each of the domain names in each of the recipient email addresses.

Next, the sending host system communicates with each host system associated with an intended recipient utilizing an email transfer protocol. For example, RFC 2821, “Simple Mail Transfer Protocol,” (“SMTP”) describes one protocol typically used for the transfer of electronic messages.

Although a sending host system could communicate with a receiving host system over any one of the more than 65,000 communication ports available to either system, by convention email transmissions are typically conducted through one or more designated ports. For example, the Internet Assigned Numbers Authority (“IANA”) has designated communication ports numbered 0 through 1023 as System or Well Known Ports and further designated port 25 for Simple Mail Transfer. See http://www.iana.org/numbers.html. Accordingly, by convention most SMTP processes are conducted by electronic communications between a sending host system's port 25 and a receiving host system's port 25.

Where a host system comprises a plurality of email servers servicing a single domain name, the DNS system provides one or more IP addresses for access to any of the servers. Thus, where a receiving email system may receive messages by a plurality of email servers, any sender querying the DNS system will receive the same unique IP address or set of unique IP addresses for the domain name. When an email or other electronic communication is made to the IP address, the receiving email system, through processes well known to those schooled in the art directs the transmission to the appropriate server within the receiving system.

DNS data may be stored at the individual client machine level as well as at the host system level. Additionally, DNS name servers are available through the Internet for inquiries that cannot be satisfied at the client machine or host system level.

As noted earlier, one data element customarily included in an email message is the email address from which the email originated. For example, an email user who prepared a message conforming to RFC 2822 would include an originating email address in the “From:” email header field such as “From: user@domain.com” in which “domain.com” is the domain name from which the message originated. Optionally, an originating email address, including a domain name, may appear in the “Sender:” email header field.

One partially effective method of blocking Spam messages known by those schooled in the art is for a Receiving Email System to identify the domains from which Spam is known to originate and then to block any future emails which are sent with originating email addresses that have that same domain name. A Receiving Email System simply compiles a list of the domain names which have sent Spam messages. This list, or “blacklist” is thereafter, referenced by the Receiving Email System whenever an email is received. If the email originated from a domain name on the blacklist, the message is blocked from delivery.

Those skilled in the art will recognize that the inverse of this technique can be, and has also been, implemented. That is, a Receiving Email System may compile a list of trusted domain names, or a “whitelist.” Thereafter, whenever a message is received by the Receiving Email System the whitelist is referenced. If the message originated from a domain name on the whitelist, the message is delivered.

Many Receiving Email Systems employ both whitelists and blacklists. If the source domain is recognized as a trusted system because it is listed on the whitelist, the email is delivered. If it is not, the Receiving Email System references a blacklist to determine whether the source has been identified as a source of Spam email and refuses delivery if it has been so identified.

Several services, such as SpamCop and MAPS, have been formed to compile, maintain and share the domain data of known spamming domains. These services allow Receiving Email Systems to reference large databases of known sources of Spam email compiled from many sources so that the Receiving Email System participating in the service may exclude email originating from a domain known to be a source of Spam email. This method of filtering unsolicited email has been implemented at both the user level, the Receiving Email System level, as well as the Internet Service Providers (ISP) level. As a matter of reference, it is estimated that ISP America On-Line blocks almost 2 billion messages per day from identified spamming systems.

However, an increasing amount of Spam is bypassing blacklist measures and capitalizing on whitelists by “spoofing” itself as having originated from legitimate domains. Spoofing occurs when a spamming system provides a false originating email address as a data element in the email or the email envelope. The domain name of the false address may be a legitimate domain name, such as “aol.com,” hotmail.com,” or “msn.com,” or it may be a fictitious domain name. Spammers falsify or “spoof” the originating email address in a Spam message in order to bypass blacklists that are blocking Spam and to hide their actual identity from Receiving Email Systems. Because there is a plethora of legitimate domain names from which legitimate email might originate, a spamming system utilizing spoofing has an almost unlimited ability to conceal its identity from Receiving Email Systems by frequently changing the domain name which it falsely provides as the source of the Spam messages being sent. As a matter of reference, it has been estimated that 70% of all Spam contains a spoofed originating email address.

Spoofing further compromises the ability of a Receiving Email System to use blacklists or whitelists to block Spam because of the potential for blocking legitimate and desired email transmissions. For example, a spammer may configure the spamming email system to send out Spam with an originating email address in the message header that identifies “hotmail.com” as the domain name from which the Spam email originated. In such a circumstance, email systems which receive these Spam messages and which utilize blacklists are faced with a dilemma. Although they could block all emails originating from the hotmail.com domain, this would have the undesirable effect of also blocking all non-Spam, desired emails coming from hotmail.com users.

Accordingly, if a Receiving Email System relies upon blacklists and whitelists only to block Spam it must either deliver spoofed Spam email or deny delivery of a significant amount of desired email. The first shortcoming occurs when a Spammer spoofs a domain name which exists on the Receiving Email System's trusted domain name list, that is, its whitelist. The second occurs when the Receiving Email System identifies a domain as a spamming domain and provides the domain data for that domain to a local or centrally maintained blacklist because the domain name was falsely shown as the originating domain for Spam email. Thereafter, when non-Spam email is originated from the domain and transmitted to the same Receiving Email System or to another Receiving Email System which references the same blacklist, the non-Spam email will be blocked.

The spoofing problem is further exacerbated by the inability of system administrators to identify all potential domain names from which non-Spam email might originate. Therefore, it has become increasingly difficult for system administrators to avoid blocking legitimate email while simultaneously stopping “spoofed” Spam because they cannot blacklist and block domain names that are heavily utilized by legitimate email senders and because they cannot be certain that some desired email will not be blocked if they add a previously unidentified spamming domain name to a blacklist.

The implementation of ineffective methods for blocking Spam poses an especially difficult problem for those who use or desire to use electronic messaging in commerce. In commercial transactions it is frequently necessary to be able to demonstrate that an electronic message was received by the intended recipient. For example, where the message constitutes a demand for payment or where the message delivers goods or services, it is useful for the sender to be able to verify delivery of the message. If a Receiving Email System utilizes less than optimal Spam detection and elimination techniques, a desired message may not be delivered. Just as significantly, a recipient may falsely deny receipt by claiming that ineffective techniques employed by an ISP provider blocked delivery. There is, therefore, a need for a method of verifying delivery of electronic messages.

Spoofing also facilitates another undesirable practice in electronic messaging: phishing. Phishing is an attempt to obtain information from an email recipient by falsely representing to be a person or entity entitled to receive such information or by falsely claiming a need for such information. For example, a phisher may send an email which is spoofed with a false origination address which appears to be a legitimate email address for a financial institution, e.g. “customerservice@chase.com.” The text of the email may request that the recipient respond by providing his or her account number, social security number, address or other sensitive information which may thereafter be used illicitly by the phisher. Alternatively, the email might direct the recipient to a web site at which the recipient is requested to provide sensitive information. Accomplished phishers frequently employ brand names and marks similar to the entity whose email address is spoofed so that it is difficult for even sophisticated recipients to recognize a phishing attempt.

Phishing poses several problems for users of electronic communications, particularly those who use or desire to use electronic communications for commercial purposes. First phishers are difficult to detect and identify and phishing attempts may not be detected until some time after a substantial number of phishing emails have been sent. A phisher may send hundreds, thousands or even millions of spoofed, phishing emails before the phishing attack is reported to the entity whose customers are targeted. Thus, a financial institution whose email address has been spoofed and whose customers have improperly disclosed sensitive information may not be aware of the attempt until the phishing results in the report of a financial loss. While early detection of a phishing effort is desirable, both because it facilitates the possible identification of the phisher and because actions can be taken to warn potential targets, under existing email methods it is seldom accomplished. A second, corollary effect is that customers are reluctant to respond to legitimate emails from financial institutions because they fear that the email may be a phishing attempt.

There is therefore, a need for method which facilitates early detection of phishing attempts and which facilitates the collection of data regarding such phishing attempts so that phishers may be identified, thwarted and prosecuted.

This applicant's U.S. application Ser. No. 10/803,120, filed Mar. 17, 2004, discloses an invention which permits a Receiving Email System to verify that an electronic message is authentic and not spoofed. Under the method disclosed in the application, a Sending Email System prepares a data record containing identifying information for each electronic message sent by the system. When a Receiving Email System receives an electronic message, it identifies the purported originating Sending Email System by referring to data in the email header and sends a confirmation request to that System. The confirmation request includes data from the email corresponding to the data which a Sending Email System uses to prepare data records for sent email. Where the email is authentic, the Sending Email System will receive the confirmation request and compare the data in the confirmation request with the data records it maintains for emails it has sent. When the Sending Email System locates a data record corresponding to the email identified by the data in the confirmation request, it will authenticate the email by replying to the Receiving Email System. Where the email has been spoofed, the Sending Email System will reply to the confirmation request by denying that it originated the email.

In a slightly different fashion, this applicant's and Leslie J. Kim's U.S. application Ser. No. 11/010,600 permits a Sending Email System to authenticate messages without maintaining a data record for each email sent. Under the method disclosed in the application, a Sending Email System prepares a data string by applying an algorithm to specified data elements of each email which sends. It then appends the data to the email and transmits the message with the data string to the intended recipient. A Receiving Email System which receives an email message first identifies the purported originating Sending Email System by referring to data in the email header and then sends a confirmation request to that System. The confirmation request includes the data string from the email message as well as the specified data element from which the data string would have been prepared by a Sending Email System. The Sending Email System will receive the confirmation request and compute a second data string by applying the same algorithm to the data elements sent in the confirmation request. If the second data string is equivalent to the data string in the confirmation request, the Sending Email System will authenticate the email by replying to the Receiving Email System. Where the data strings are not equivalent (because, for example, the email received by the Receiving Email System has been spoofed), the Sending Email System will reply to the confirmation request by denying that it originated the email.

Even where the method disclosed in U.S. application Ser. No. 10/803,120 or the method disclosed in U.S. application Ser. No. 11/010,600 is employed, there is still a need for a method to verify that an electronic message has been delivered to the intended recipient and to accumulate data pertaining to spoofed email, particularly where such email may be a phishing attempt. The present invention addresses these needs.

### DISCLOSURE OF THE INVENTION

The present invention provides a method for verifying the delivery of electronic messages by automatically recording data related to the response to a request for authentication for such message when the response to the confirmation request from a recipient is in the affirmative. Similarly, the present invention provides a method for the collection of data related to electronic messages sent with false origination addresses by automatically requesting that the recipient of such messages forward a copy of the message or specified data elements from the message to the purported sender of the email message, so that the purported sender can store and analyze such information.

The invention is a system that can be employed in conjunction with a variety of electronic message delivery and email protocols, including, for example, SMTP and SendMail. The system comprises a software module or Sending Module, which interacts with a device sending electronic messages, that is a Sending System and a second software module or Receiving Module, which interacts with a device receiving electronic messages, that is a Receiving System. The first and second software modules of the invention can be developed and implemented in a variety of programming languages and can be deployed on a variety of electronic systems. The first and second modules comprise the necessary code to perform the functions associated with a Sending System and a Receiving System respectively.

According to the invention, when a Sending System transmits an electronic message for delivery, the Sending Module prepares an Information Record which includes data uniquely identifying the electronic message which is being sent for delivery. Preferably, the Information Record includes the time and date that the message was prepared, data identifying the originator of the message, and data identifying the intended recipients of the message. Optionally, the Information Record may contain additional data related to the electronic message such as a unique message identifier. For example, in the case of an email message, the unique identifier contained in an email headers “Message-ID:” field as recommended by RFC 2822, “Internet Message Format” may be utilized.

Those schooled in the art will recognize that a variety of data elements can be utilized to uniquely identify an electronic message. For example, a checksum of the text of an email message or a portion of the message, or data prepared according to an algorithm applied to the message or a portion of the message could be used as a unique message identifier.

The Information Records for all of the electronic messages sent by the Sending System are stored in a database and organized for efficient retrieval. Preferably, all of the Sending Modules and Receiving Modules in the communication system practicing the invention will, by pre-arrangement, uniquely identify each electronic message by the same data element or set of data elements or by data prepared by the same algorithm.

According to the invention, when a “suspect electronic message” that is, an electronic message which the Receiving System cannot otherwise verify as authentic and desired, is received by a Receiving System, the Receiving Module withholds the suspect message from delivery. Next, the Receiving Module determines the identity of the Sending System from which the suspect message has purportedly been transmitted. This data may ordinarily be ascertained by referencing data in the suspect message, or, alternatively, from data in an envelope accompanying the message or from data transmitted during the transmission of the message. Next, the Receiving Module sends a confirmation request to the Sending System from which the suspect email has purportedly originated.

Those schooled in the art will recognize that, in the case of email messages, a Receiving Module can determine the Internet Protocol (IP) address of the purported Sending Email System by utilizing DNS in the same fashion that a Sending Email System utilizes DNS to determine the IP address for an email that it intends to send. Moreover, those schooled in the art will recognize that, in the event that a suspect email received by the Receiving Email System is a spoofed email, that is an email falsely identifying an originating email address with a domain name other than the system from which the email originated, the IP address provided to the Receiving Module by querying DNS will correspond to the domain name falsely identified as the originator and not the actual source for the email.

The confirmation request from the Receiving Module contains data uniquely identifying the suspect message which, by pre-arrangement, corresponds to the data which a Sending Module in the same communication network would have stored if the message was sent by a Sending System practicing the invention. Preferably, the confirmation request includes the date and time that the suspect electronic message was prepared, the identification of the intended recipients of the message and data identifying the originator of the suspect email. Optionally, the confirmation request may include a unique message identifier.

When a Sending System receives a confirmation request from a Receiving Module, it communicates the confirmation request to the Sending Module. The Sending Module references the database containing Information Records for all of the electronic messages transmitted by the Sending System. If the Sending Module finds an Information Record which was prepared for the suspect message, the Sending Module replies to the confirmation request confirming that the Sending System transmitted the suspect message. Additionally, the Sending Module updates the Information Record by adding data related to the confirmation request reply. Preferably this data would include the date and time the authentication reply was transmitted and the electronic address to which the reply was transmitted. Optionally, the data requested may include the IP address of the system initiating the confirmation request, the nature of the system initiating the confirmation request, (i.e. whether such system is a gateway email system, or a single computer running an email application, etc.) or data uniquely identifying the Receiving Module initiating the request.

If the Sending Module does not find an Information Record which was prepared for the suspect message, the Sending Module replies to the confirmation request denying that the Sending System transmitted the suspect message. The reply denying that that the Sending System originated the request also contains a request to the Receiving System to transmit a copy of the electronic message to the Sending System. Optionally, the Sending System may request that the Receiving Module transmit specified data elements related to the suspect message such as the header information, the IP addresses of servers forwarding the message or the message envelope. Further, the Sending System may also request that the message or such specified data elements be forwarded by the Receiving System to a designated centralized system serving as a central repository for storing and analyzing spoofed email or spam email.

When the Receiving System receives a reply to the confirmation request affirming that the Sending System sent the suspect message, the Receiving Module releases the suspect message for delivery to the intended recipient. When the Receiving System receives a reply to the confirmation request denying that the Sending System sent the suspect message and requesting a copy of the message, the Receiving Module forwards or transmits a copy of the message or the requested specified data elements to the Sending System.

In an alternative embodiment of the invention, when a Sending System transmits an electronic message for delivery, the Sending Module executes a pre-determined algorithm on one or more components of the message. The application of the algorithm to the message or portions thereof results in the generation of a data string or “key” for each particular message. Preferably, the algorithm would be run on data components which include the time and date that the message was prepared, data identifying the originator of the message, and data identifying the intended recipients of the message. Optionally, the key may also be derived from additional data contained within the electronic message or the message header. For example, in the case of an email message, the key may be derived from the body of the message text or from one or more data elements in the message header.

Those schooled in the art will recognize that an algorithm may be applied to a variety of data elements in order to generate a key that can be utilized to identify an electronic message. Regardless of the manner in which it is generated, this key is then incorporated into or associated with the electronic message in some fashion. Typically the key would simply be incorporated into the body of the message as text. However, those skilled in the art will recognize that such a key may be transmitted in the header of the message, in the “Message-ID” field, as an electronic file attachment or in some other manner.

When a suspect electronic message is received by a Receiving System, the Receiving Module withholds the suspect message from delivery. Next, the Receiving Module determines the identity of the Sending System from which the suspect message has purportedly been transmitted. This data may ordinarily be ascertained by referencing data in the suspect message, or, alternatively, from data in an envelope accompanying the message or from data transmitted during the transmission of the message. Next, the Receiving Module sends a confirmation request to the Sending System from which the suspect email has purportedly originated.

The confirmation request from the Receiving Module contains two elements, namely (1) the data string or “key” and (2) the components of the message that, by pre-arrangement within the communication network would have been used by a Sending System practicing the invention to prepare a key for a message.

When a Sending System receives a confirmation request from a Receiving Module, it communicates the confirmation request to the Sending Module. The Sending Module then reapplies the algorithm to the data components provided in the confirmation request and generates a second data string or “key.” If the Sending Module finds that the second key is identical to the key transmitted in the confirmation request, the Sending Module replies to the confirmation request confirming that the Sending System transmitted the suspect message. Additionally, the Sending Module prepares a data record to be stored by the Sending System in a message verification database which includes data related to the confirmation request reply. Preferably this data would include the date and time the authentication reply was transmitted and the electronic address to which the reply was transmitted.

If the Sending Module determines that the second key is not identical to the key found in the confirmation request, the Sending Module replies to the confirmation request denying that the Sending System transmitted the suspect message. The reply denying that that the Sending System originated the request also contains a request to the Receiving System to transmit a copy of the electronic message to the Sending System.

When the Receiving System receives a reply to the confirmation request affirming that the Sending System originated the suspect message, the Receiving Module releases the suspect message for delivery to the intended recipient. When the Receiving System receives a reply to the confirmation request denying that the Sending System sent the suspect message and requesting a copy of the message, the Receiving Module forwards a copy of the message to the Sending System.

Those skilled in the art will appreciate that each Sending System practicing the invention in the communication network does not have to apply the same algorithm to the data components which, by pre-arrangement within the system, are used to prepare a key. Additionally, a Sending System may optionally utilize different algorithms for different email messages, so long as the data components from which the key is prepared and which is forwarded in a confirmation request allow the Sending System to identify the algorithm that was used. For example, in a communication network where, by pre-arrangement a message key is prepared by applying an algorithm to the date and time when the message was originated, a Sending System could periodically change the algorithm which it applies. When a confirmation request is returned from a Receiving System, the Sending System would identify the algorithm used by reference to the date and time data returned in the confirmation request. Similarly, in a communication network where, by pre-arrangement a message key is prepared by applying an algorithm to the sender's email address, a Sending System could utilize different algorithms for various senders. When a confirmation request is returned from a Receiving System, the Sending System would identify the algorithm used by reference to the sender's email address returned in the confirmation request. In this way, the possibility that unauthorized users could identify and begin using the algorithm used by an authorized Sending System may be minimized.

Those skilled in the art will also appreciate that where all Sending and Receiving Systems in a network practice the invention by applying the same algorithm to pre-arranged data elements in email messages, the Receiving System may perform the confirmation process without forwarding a confirmation request to the Sending System. In such a network, a Receiving System which receives a suspect email would apply the agreed upon algorithm to the pre-arranged data elements in the suspect message and compare the resulting key with the key in the suspect message. If the keys are equivalent and the message is authentic, the Receiving System may save or, optionally, transmit information concerning the delivery of the message to a centralized repository for the recording of message delivery verifications. In similar fashion, if the keys are not equivalent, the Receiving System may transmit the suspect message or specified data elements from the suspect message to the Sending System or, optionally, to a centralized system serving as a central repository for the storage of data related to spoofed or spam email and, optionally, serving to analyze such data.

Where the invention is practiced by systems transmitting email messages, the confirmation request and the reply to the confirmation request are, preferably, performed by port to port communication between a Receiving Email System and a Sending Email System. For example, the communication may be conducted through one of the Registered Ports, that is, a port in the range 1024 to 49151. Under these circumstances, when a Receiving Module attempts to make a confirmation request of a Sending Email System which has not employed the invention and, therefore, does not have a Sending Module, the Sending Email System will either deny access to the port or fail to respond to the request.

### BRIEF DESCRIPTION OF DRAWINGS

FIG. 1 is a schematic illustration of a Sending Email System and a Receiving Email System processing email according to the invention.

FIG 2. is a schematic illustration of a Sending Email System and a Receiving Email System processing spam email according to the invention.

FIG. 3 is a schematic illustration of plural Sending Email Systems and a Receiving Email System processing email according to the invention and in which a centralized Confirming Email System is utilized by one Sending Email System and one client user.

### BEST MODE FOR CARRYING OUT THE INVENTION

The present invention provides a method for verifying the delivery of electronic messages by recording data related to the response to a request for authentication for such message when the response to the authentication request from a recipient is in the affirmative and a method for collecting data related to electronic messages sent with false origination addresses by requesting, receiving and storing data related to such messages when the response to an authentication request from a recipient is in the negative. The description provided here is presented to enable one of ordinary skill in the art to make and practice the invention. However, various modifications to the preferred embodiments which are described will be apparent to those skilled in the art. Additionally, although the present invention is described in relation to the detection of Spam email messages, those skilled in the art will appreciate that the system and method described may also be applied to other forms of electronic communication including, for example, text messaging by cellular telephones or voice over Internet Protocol (VOIP) messaging.

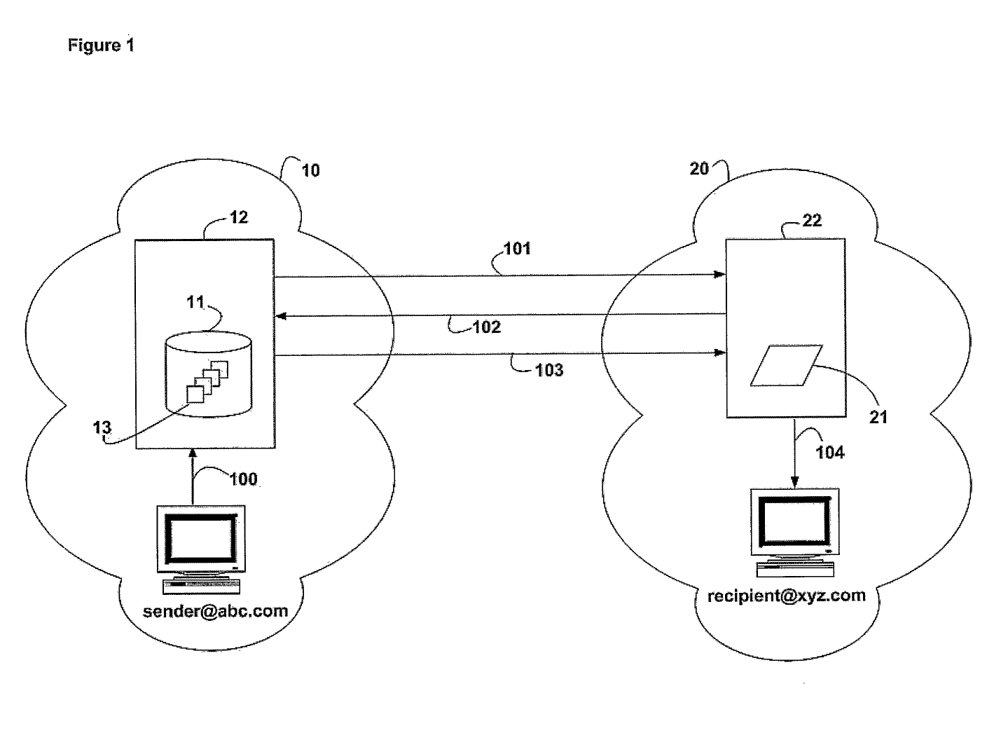

A preferred embodiment of the invention is shown in FIG. 1. A Sending Email System (10) servicing the domain name abc.com is disposed to send email messages prepared by users with email addresses including the domain name abc.com. The Sending Email System (10) is in communication with a Sending Module (12). A Receiving Email System (20) servicing the domain name xyz.com is disposed to receive and deliver email messages to users with email addresses including the domain name xyz.com. The Receiving Email System (20) is in communication with a Receiving Module (22).

Those schooled in the art will recognize that the Sending Email System may consist of a single computer running an email application (for example, Microsoft Outlook), an email server transmitting emails prepared by a plurality of users and serving one or more domain names, a plurality of email servers sending emails prepared by a plurality of users and serving one or more domain names, or a Relay Email System, that is, a system receiving emails from another Sending Email System and forwarding these with or without modification to a Receiving Email System. Similarly, those schooled in the art will recognize that the Receiving Email System may consist of a single computer running an email application, an email server, a plurality of servers, or a Gateway Email Systems.

Gateway Email Systems include those systems which receive and forward emails to a plurality of Receiving Email Systems and additionally, those which operate to forward messages received in one email transport environment to an email recipient in another email transport environment. For example, a Gateway Email System may operate to receive messages by SMTP and forward them to systems or users receiving messages in SendMail.

While for clarity of description of the invention the receiving and sending functions of each email system have been segregated, those schooled in the art will recognize that the sending and receiving functions may be and ordinarily are performed by a single computer serving as an email server.

Referring to FIG. 1, a Sending Email System (10) receives an email message (100) prepared by user with the email address sender@abc.com to be sent to a recipient with the email address recipientxyz.com. Consistent with RFC 2822, “Internet Message Format”, the sender's email address and the recipients' email address appear in the header portion of the email message at the header fields “From:” and “To” respectively . Additionally and also consistent with RFC 2822, the date and time which the message was prepared is inserted at the header “Date:” Prior to the transmission of the prepared email message, the Sending Module (12) generates an Information Record (13) containing data uniquely identifying the email being transmitted. Preferably the Information Record (13) includes data contained in the header of the email including the sender's address, the recipient's address and the date and time when the email was prepared. Additionally, an Identification Data String, that is a unique data element, such as a unique alphanumeric identifier, may optionally be generated by the Sending Module (12) and included in the Information Record (13) and in the header or body of the email message being sent. For example, the unique identifier included at the header “Message-ID:” as recommended by RFC 2822 may be used as an Identification Data String. Optionally, other Identification Data Strings, such as a checksum for the message text, may be prepared and stored in the Information Record related to the message.

The Information Record is stored by the Sending Module in an Information Record database (11). The database is organized for efficient search and retrieval of the Information Records. Those schooled in the art will recognize that the Information Record database may be stored on the same computer on which the sending module resides or may optionally be stored externally on a computer in communication with the Sending Module.

The email message is transmitted (101) by the Sending Email System via standard and well-known methods to the Receiving Email System (20) of the intended recipient. When the Receiving Email System (20) receives the email message or the suspect email, the Receiving Module (22) temporary withholds delivery of the suspect email by routing the suspect email into a temporary hold queue (21) while it performs the confirmation process.

During the confirmation process, the Receiving Module (22) first determines the domain name in the originating email address from the message header of the suspect email. Next, the Receiving Module (22) prepares a confirmation request and transmits it (102) to the Sending Email System associated with the domain name identified as the source of the suspect email message. The confirmation request contains identification data which uniquely identifies the suspect email and by pre-arrangement, corresponds to the data which Sending Modules practicing the invention within the communication network use to uniquely identify emails. Preferably this data includes the date and time the suspect email was prepared, the sender's email address, and the addresses of the intended recipients of the email. This information will typically be extracted from the header fields of the suspect email.

Optionally, by pre-arrangement, the email message sent by a Sending Email System (10) contains an Identification Data String used by the Sending Module (12) to identify the email. In this circumstance, the confirmation request sent by the Receiving Email System (20) includes the Identification Data String in addition to other identification data, including, for example, the date and time that the email message was prepared, the email address of the sender of the email and the email addresses of the intended recipients of the email.

When a confirmation request is received by the Sending Email System (10), the Sending Email System communicates the confirmation request to the Sending Module (12). The Sending Module (12) compares the data submitted in the confirmation request with the Information Records stored in its Information Record database (11). When the Sending Module locates an Information Record (13) prepared for the email identified by the identification data submitted in the confirmation request, the Sending Module (12) replies to the confirmation request with an affirmation (103) that the Sending Email System (10) sent the suspect email.

Contemporaneous with the transmission of the reply, the Sending Module (12) updates the Information Record (13) for the email by including the date and time when the affirmative reply was sent as well as the address for the Receiving Email System to which the reply was transmitted. In this way the Sending Email System maintains a record of verified delivery of the message to the Receiving Email System.

Preferably, where the Sending Email System comprises at least one email server, the Receiving Email System communicates directly with the Sending Email System via port to port communications rather than by email transmission. For example, the communication may be pre-arrangement between systems practicing the invention in the communications network, be conducted through one of the Registered Ports, that is, a port in the range 1024 to 49151.

Where the Sending Email System comprises a single client computer running an email application and which may be offline, it may be necessary for the Receiving Module to communicate with the Sending Module by specialized email communications. In such a circumstance, the Sending Module, by pre-arrangement with the Receiving Module, may include in the original email message data identifying the original email message as a transmission for which the confirmation request must be conducted by specialized email communication. Additionally, in this circumstance a confirmation request email includes data identifying the confirmation request email as a transmission for which a confirmation request should not be prepared.

When the Receiving Module receives a reply to the confirmation request that affirms that the Sending Email System sent the suspect email, the email is withdrawn from the temporary hold queue (21) and made available for delivery (104) to the recipient at the address recipient@xyz.com by the Receiving Email System (20).

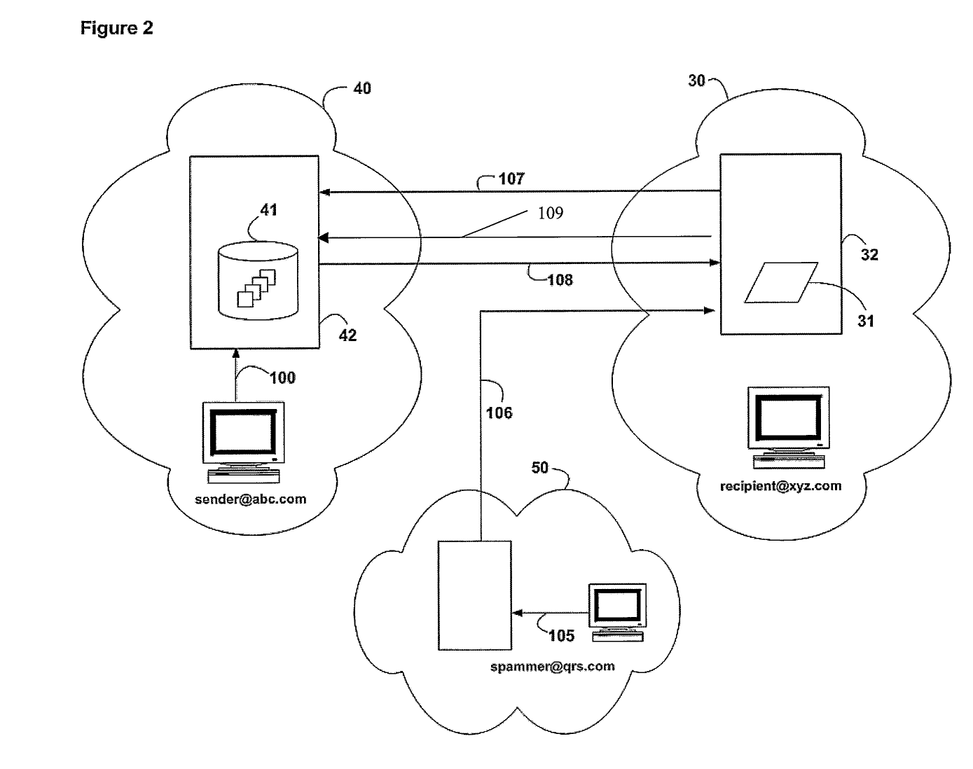

FIG. 2 illustrates a preferred embodiment of the invention in operation to prevent the delivery of unsolicited and undesired Spam email and to facilitate the collection of data related to such email. A Phishing Email System (50) is disposed to transmit Spam email messages constituting a phishing attempt. A Sending Email System (40) servicing the domain name abc.com is disposed to transmit email messages prepared by users with email addresses including the domain name abc.com. The Sending Email System (40) includes a Sending Module (42). The Sending Module comprises an Information Record database (41). A Receiving Email System (30) servicing the domain name xyz.com is disposed to receive and deliver email messages to users with email addresses including the domain name xyz.com. The Receiving Email System (30) includes a Receiving Module (32).

Referring to FIG. 2, a Phisher at email address spammerqrs.com prepares a Spam email to be sent to recipient at email address recipient@xyz.com and sends it (105) to the Phishing Email System (50). However, in order to avoid detection, Phisher inserts a false origination address, senderabc.com, in the header of the Spam email message. In addition to the false origination address, the recipients' email address also appears in the header portion of the email message. The Spam email message also contains date and time data inserted by the Spammer at the header field, “Date:”.

The Spam email message is transmitted (106) by the Phishing Email System (50) via standard and well-known methods to the Receiving Email System (30) of the intended recipient. When the Receiving Email System (30) receives the Spam email message or the suspect email, the Receiving Module (32) temporary suspends delivery of the suspect email by routing the suspect email into a temporary hold queue (31) while it performs the confirmation process.

During the confirmation process, the Receiving Module (32) first determines the domain name for the purported originating email address from the message header of the suspect email. Because the Phisher has falsely provided senderabc.com as the originating email address, the Receiving Module (32) will determine that abc.com is the domain name of the originating domain. Next, the Receiving Module (32) prepares a confirmation request and transmits it (107) to the domain, abc.com, identified as the source of the suspect email message. The confirmation request contains data which uniquely identifies the suspect email and which, by pre-arrangement, corresponds to data used by Sending Modules practicing the invention in the communication network to uniquely identify email messages. Preferably this data includes the date and time the suspect email was sent, the sender's email address, and the email address of the intended recipient of the email.

When a confirmation request is received by the Sending Email System (40), the Sending Email System communicates it to the Sending Module (42). The Sending Module (42) compares the data submitted in the confirmation request with the Information Records stored in its Information Record database (41). When the Sending Module fails to locate an Information Record prepared for the email corresponding to the data submitted in the confirmation request, the Sending Module (42) replies to the confirmation request with a denial (108) that the Sending Email System transmitted the suspect email and a request that the Receiving Email System forward a copy of the message to it.

When the Receiving Module receives a reply to the confirmation request that denies that the Sending Email System transmitted the suspect email and requests a copy of it, the Receiving Module (32) forwards the message (109) to the Sending Email System. When the Sending Email System receives a copy of the message it may analyze it and determine whether additional action is required. For example, the Sending Email System may recognize the email as a phishing attempt and may determine to warn potential recipients of such attempts of the phishing attempt. Additionally, the Sending Email System may use information from the message or from the message header (e.g. data identifying the servers through which the message was transmitted) to identify the source of the attempt or the identity of the phisher. The Sending Email System may also store the message for further analysis later in conjunction with other spam or spoofed emails.

In the preferred embodiment of the system which is described, the respective Receiving and Sending Modules communicate with one anther via port to port communications. Where the Sending Email System comprises a single client computer running an email application which may be offline, it may be necessary for the Receiving Module to communicate with the Sending Module by specialized email communications. In such a circumstance, the Sending Module, by pre-arrangement with the Receiving Module, may include in the original email message data identifying the original email message as a transmission for which the confirmation request must be conducted by specialized email communication. Additionally, in this circumstance a confirmation request email includes data identifying the confirmation request email as a transmission for which a confirmation request should not be prepared.

Where the Receiving Module (32) attempts to communicate a confirmation request to a Sending Email System that is not practicing the invention (not shown), the Receiving Module will either be denied access to the port for such confirmation requests or, alternatively, will be granted access but fail to receive an appropriate response from the Sending Email System.

Communication between Sending and Receiving Modules may also occur by Secure Sockets Layer protocols and, where additional security is desired, the communications may be encrypted and decrypted according to methodologies commonly known in the art.

Those skilled in the art will recognize that where a Sending Email System comprises a plurality of email servers servicing a single domain name, the Sending Module for the Sending Email System may comprise a centralized Information Record database in communication with each of the Sending Email System's email servers. In this circumstance each of the email servers of the Sending Email System will extract the data necessary to compile an Information Record from each email sent by the server. This data is communicated to the centralized Information Record database.

Similarly, when a confirmation request is received from a Receiving Email System, the Sending Email System will forward the request to the centralized Information Record database and the Sending Module will compare the data in the confirmation request with the data in the centralized Information Record database to determine whether the email corresponding to the confirmation request was transmitted by one of the email servers in the Sending Email System. When the Sending Module confirms that an Information Record prepared for the email message exists in the database it will reply in the affirmative and communicate with the centralized Information Record database to append data related to the authentication to the Information Record for the message. When the Sending Module fails to locate an Information Record prepared for the email message it will reply with a denial that the Sending Email System transmitted the email message corresponding to the data in the confirmation request and request that the Receiving Email System transmit a copy of the message or data related to the message to it.

Those skilled in the art will recognize that the invention may also be practiced where the Sending Module does not prepare an Information Record, but alternatively, prepares a data string or “key” for each message sent by applying an algorithm to specified data elements of the message. The Sending Module then appends the key to the message. In this circumstance, the confirmation request forwarded by the Receiving Module includes the key and the data from the message which corresponds to data from which the key would be prepared by a Sending Module practicing the invention in the network. When the Sending Module receives the confirmation request it prepares a second key by applying the algorithm to the data elements in the confirmation request and then compares the first and second keys. If they equivalent, the Sending Module replies to the confirmation request in the affirmative and prepares a data record containing data related to the confirmation request reply, including preferably, the date and time the reply was transmitted and the address of the Receiving Email System to which the reply was transmitted. In this manner, the Sending Email System retains a record that the email was delivered.

If the first and second keys are not equivalent, the Sending Module replies to the confirmation request denying that the email message was transmitted by it and requesting that the Receiving Module forward a copy of the message. When the Receiving Module receives a reply to the confirmation request that denies that the Sending Email System transmitted the suspect email and requests a copy of it, the Receiving Module forwards the message to the Sending Email System. In this way, the Sending Email System may analyze it and determine whether additional action is required. For example, the Sending Email System may recognize the email as a phishing attempt and may determine to warn potential recipients of such attempts of the phishing attempt. Additionally, the Sending Email System may use information from the message or from the message header (e.g. data identifying the servers through which the message was transmitted) to identify the source of the attempt or the identity of the phisher. The Sending Email System may also store the message for further analysis later in conjunction with other spam or spoofed emails.

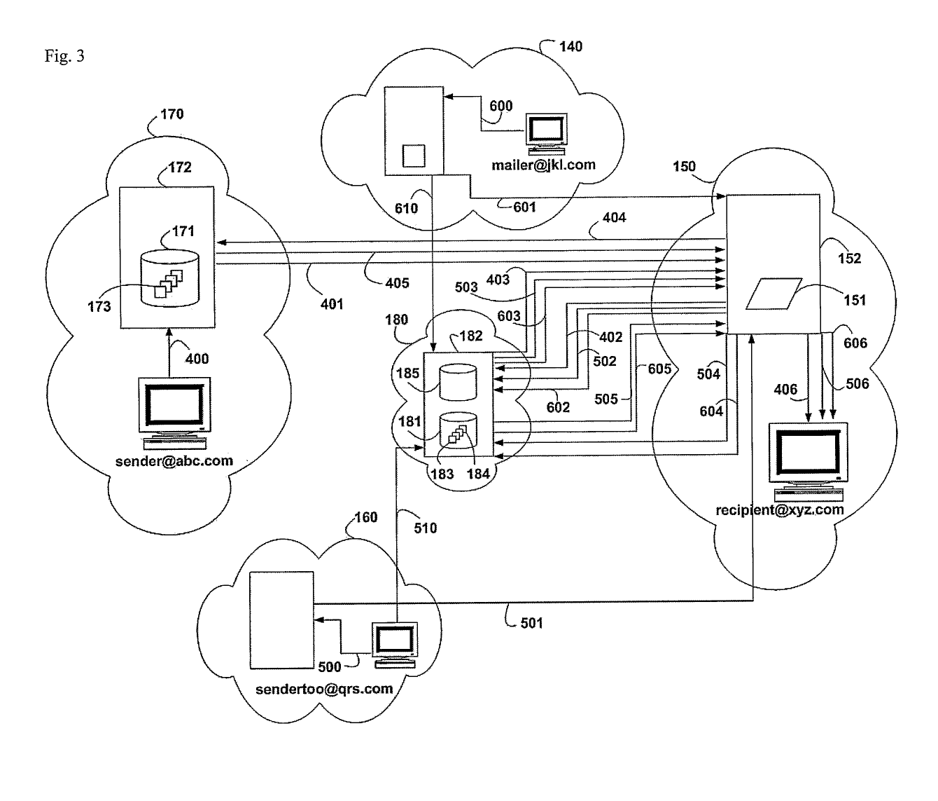

In the embodiments illustrated thus far, the Sending Module is an integral part of a Sending Email System although the functions of the Sending Module may be distributed among a plurality of computers within the Sending Email System. Those skilled in the art will also recognize that the Sending Module functions may also be performed by a Confirming Email System operating independent from the Sending and Receiving Email Systems. FIG. 3. depicts an electronic communication network in which some of the Sending Email Systems in the network are practicing the invention. By pre-arrangement within the communication network, for confirmation purposes, each Sending Email System practicing the invention identifies each email sent by specified identification data. Preferably this data includes the sender's email address, the email addresses of the intended recipients and the date and time the email was prepared and an Identification Data String. The Identification Data String may be a data string prepared by an algorithm such as a checksum of the message text.

Referring to FIG. 3, a Sending Email System (170) servicing the domain name abc.com is disposed to transmit email messages prepared by users with email addresses including the domain name abc.com. The Sending Email System (170) includes a Sending Module (172). The Sending Module (172) comprises an Information Record database (171)

A Receiving Email System (150) servicing the domain name xyz.com is disposed to receive and deliver email messages to users with email addresses including the domain name xyz.com. The Receiving Email System (150) is in communication with a Receiving Module (152).

A Confirming Email System (180) is disposed to receive electronic communications, including email messages, and comprises a Centralized Sending Module (182). The Centralized Sending Module includes a Centralized Information Record database (181) and a Centralized Serviced Name Registry (185). The Centralized Serviced Name Registry includes a record of each domain name utilizing the Confirming Email System (180), as well as the email address of any domain name client utilizing the Confirming Email System for the confirmation of suspect emails.

A second Sending Email System (140) servicing the domain name jkl.com is disposed to transmit email messages prepared by users with email addresses including the domain name jkl.com. The second Sending Email System (140) is in communication with the Confirming Email System (180).

A third Sending Email System (160) servicing the domain name qrs.com is disposed to transmit email messages prepared by users with email addresses including the domain name, qrs.com.

Referring to FIG. 3, the first Sending Email System (170) receives an email message (400) prepared by user with the email address senderabc.com to be transmitted to a recipient with the email address recipientxyz.com. Consistent with RFC 2822, “Internet Message Format”, the sender's email address and the recipient's email address appear in the header portion of the email message at the header fields “From:” and “To” respectively. Additionally and also consistent with RFC 2822, the date and time which the message was prepared is inserted at the header “Date:”

Prior to the transmission of the prepared email message, the Sending Module (172) of the first Sending Email System generates an Information Record (173) containing the specified identification data for the email consistent with the pre-arrangement within the network regarding the data used to identify emails for confirmation purposes. The Information Record (173) is stored by the Sending Module (172) in an Information Record database (171). The database is organized for efficient search and retrieval of the Information Records.

The second Sending Email System (140) receives an email message (600) prepared by user with the email address mailerjkl.com to be sent to a recipient with the email address recipient@xyz.com. Consistent with RFC 2822, “Internet Message Format”, the sender's email address and the recipients' email address appear in the header portion of the email message at the header fields “From:” and “To” respectively . Additionally and also consistent with RFC 2822, the date and time which the message was prepared is inserted at the header “Date:”

Prior to the transmission (601) of the prepared email message to the Receiving Email System, the second Sending Email System (140) extracts the data from the email message necessary to compile an Information Record containing the specified identification data for the email consistent with the pre-arrangement within the network regarding the data used to identify emails for confirmation purposes. The second Sending Email System (140) communicates the data (610) to the Confirming Email System (180). This communication is, preferably, performed by port to port communication between the second Sending Email System (140) and the Confirming Email System (180).

The Confirming Email System communicates the data to the Centralized Sending Module (182) which generates an Information Record (183) containing the specified identification data for the email consistent with the pre-arrangement within the network regarding the data used to identify emails for confirmation purposes.

The third Sending Email System (160) receives an email message (500) prepared by user with the email address sendertoo@qrs.com to be sent to a recipient with the email address recipient@xyz.com. Consistent with RFC 2822, “Internet Message Format”, the sender's email address and the recipients' email address appear in the header portion of the email message at the header fields “From:” and “To” respectively . Additionally and also consistent with RFC 2822, the date and time which the message was prepared is inserted at the header “Date:” The user with the email address sendertooqrs.com also sends (510) a copy of the email message to the Centralized Communication System (180).

Although the third Sending Email System (160) is not practicing the invention, the client machine for sendertoo@qrs.com transmits a copy of the email message to the Confirming Email System (180) so that confirmation may be conducted by the Confirming Email System (180). Those skilled in the art will recognize that this may be accomplished simply by identifying an email address for the Confirming Email System (180) as a cc: or bcc: recipient of the email message.

Upon receipt of the email message sent by sendertoo@qrs.com, the Centralized Sending Module (182) of the Centralized Communication System generates an Information Record (184) containing the specified identification data for the email consistent with the pre-arrangement within the network regarding the data used to identify emails for confirmation purposes.

The Information Record (183) prepared for the email message sent by mailerjkl.com and the Information Record (184) prepared for the email message sent by sendertoo@qrs.com are stored by the Centralized Sending Module (182) in an Information Record database (181). The database is organized for efficient search and retrieval of the Information Records.

The first (401), second (601) and third (501) email messages are transmitted by the first (170), second (140) and third (160) Sending Email Systems via standard and well-known methods to the Receiving Email System (150) of the intended recipient. When the Receiving Email System (150) receives the first (401) second (601), and third (501) suspect emails, the Receiving Module (152) temporary withholds delivery of each of the suspect emails by routing each suspect email into a temporary hold queue (151) while it performs the confirmation process.

During the confirmation process, the Receiving Module (152) first transmits a Confirmation Source Request to the Centralized Sending Module (182) for each of the suspect emails. The Confirmation Source Request for each email contains data identifying the purported sender of each suspect email. Preferably the Confirmation Source Request includes the email address of the purported sender for each suspect email. The Confirmation Source Request for the first suspect email (402) includes data identifying sender@abc.com as the purported sender, the Confirmation Source Request for the second suspect email (602) includes mailerjkl.com as the purported sender and the Confirmation Source Request for the third suspect email (502) includes sendertoo@qrs.com as the purported sender. Upon receipt of each Confirmation Source Request, the Confirming Email System (180) compares the data identifying the purported sender with data in the records of the Centralized Serviced Name Registry (185) to determine whether the Confirming Email System (180) performs confirmation functions for the user or domain identified by each Confirmation Source Request.

When the Confirming Email System fails to identify a record in the Centralized Serviced Name Registry corresponding to the purported sender in the first Confirmation Source Request, the Confirming Email System replies (403) to the first Confirmation Source Request with a denial that it can confirm the first suspect email. When the Confirming Email System identifies a record in the Centralized Serviced Name Registry corresponding to the purported sender in the second and third Confirmation Source Requests, the Confirming Email System replies to each request (603 and 503) with an affirmation that it may perform a confirmation.

Upon receipt of the first reply (403) from the Confirming Email System denying that the Confirming Email System (180) may perform a confirmation for the first suspect email, the Receiving Module (152) determines the domain name for the originating email address from the message header of the first suspect email. Next, the Receiving Module (122) prepares and transmits a first Confirmation Request (404) corresponding to the first suspect email (401) and transmits the first Confirmation Request to the Sending Email System associated with the domain name identified as the source of the suspect email message, that is, the first Sending Email System (170). The first Confirmation Request contains the specified identification data for the first suspect email consistent with the pre-arrangement within the network regarding the data used to identify emails for confirmation purposes.

Upon receipt of the second and third replies (503 and 603) from the Confirming Email System affirming that the Confirming Email System can perform confirmation for the second and third suspect emails, the Receiving Module (122) prepares and transmits a second Confirmation Request (604) corresponding to the second suspect email (601) to the Confirming Email System (180) and prepares and transmits a third Confirmation Request (504) corresponding to the third suspect email (501) to the Confirming Email System (180). The second and third Confirmation Requests contain the specified identification data for the second and third suspect email respectively consistent with the pre-arrangement within the network regarding the data used to identify emails for confirmation purposes.

When the first Confirmation Request (404) is received by the first Sending Email System (170) the Sending Email System communicates the request to the Sending Module (172). The Sending Module (172) compares the data submitted in the first Confirmation Request with the Information Records stored in its Information Record database (171). When the Sending Module locates an Information Record (173) prepared for the email identified by the identification data submitted in the first Confirmation Request, the Sending Module (172) replies to the first Confirmation Request with an affirmation (405) that the first Sending Email System (170) sent the first suspect email. Additionally, the Sending Module (172) appends data related to the reply to the Information Record (173) for the first email message. Preferably this data includes the date and time the reply was forwarded and the address of the Receiving Email System to which the reply was transmitted.

When the Receiving Module receives the affirmation reply (405) to the first Confirmation Request (404) that affirms that the first Sending Email System (170) sent the first suspect email, the email is withdrawn from the temporary hold box (151) and made available for delivery (406) to the recipient at the address recipient@xyz.com by the Receiving Email System (150).

When the second Confirmation Request (604) is received by the Confirming Email System (180), the Confirming Email System communicates the request to the Centralized Sending Module (182). Similarly, when the third Confirmation Request (504) is received by the Confirming Email System (180), the Confirming Email System communicates the request to the Centralized Sending Module (182).

The Centralized Sending Module (182) compares the data submitted in the second Confirmation Request with the Information Records stored in its Information Record database (181). When the Centralized Sending Module locates an Information Record (183) prepared for the email identified by the identification data submitted in the second confirmation request, the Centralized Sending Module (182) replies to the confirmation request with an affirmation (605) confirming the authenticity of the second suspect email. Additionally, the Centralized Sending Module (182) appends data related to the reply to the Information Record (183) for the second email message. Preferably this data includes the date and time the reply was forwarded and the address of the Receiving Email System to which the reply was transmitted

In like fashion, the Centralized Sending Module (182) compares the data submitted in the third Confirmation Request with the Information Records stored in its Information Record database (181). When the Centralized Sending Module locates an Information Record (184) prepared for the email identified by the identification data submitted in the third confirmation request, the Centralized Sending Module (182) replies to the confirmation request with an affirmation (505) confirming the authenticity of the third suspect email. Additionally, the Centralized Sending Module (182) appends data related to the reply to the Information Record (184) for the first email message. Preferably this data includes the date and time the reply was forwarded and the address of the Receiving Email System to which the reply was transmitted

When the Receiving Module receives a reply to the second confirmation request confirming the authenticity of the second suspect email, the email is withdrawn from the temporary hold queue (151) and made available for delivery (606) to the recipient at the address recipientxyz.com by the Receiving Email System (150). When the Receiving Module receives a reply to the third Confirmation Request confirming the authenticity of the third suspect email, the email is withdrawn from the temporary hold queue (151) and made available for delivery (506) to the recipient at the address recipientxyz.com by the Receiving Email System (150).

While not depicted in FIG. 3, when the Sending Module (172) receives a confirmation request for an email message which it did not originate, the Sending Module (172) will send a reply to the system transmitting the request denying the authenticity of the email and requesting that the system transmit a copy of the email to it. Alternatively, the Sending Module may request that the system transmitting the request send specified data related to the email message. For example, the Sending Module may request that the header information or the message envelope be transmitted to it. The Sending Module may thereafter analyze the message and the data or store it for later analysis in conjunction with other spoofed messages.

Similarly, while not depicted in FIG. 3, when the Centralized Sending Module (182) receives a confirmation request for an email message which was not originated by one of the clients it services, the Centralized Sending Module (182) will send a reply to the system transmitting the request denying the authenticity of the email and requesting that the system transmit a copy of the email to it. Alternatively, the Centralized Sending Module may request that the system transmitting the request send specified data related to the email message. For example, the Centralized Sending Module may request that the header information or the message envelope be transmitted to it. The Centralized Sending Module may thereafter analyze the message and the data or store it for later analysis in conjunction with other spoofed messages.

Preferably, the communications between the Receiving Email System and the Confirming Email System are conducted via port to port communications. Further, those skilled in the art will recognize that the Receiving Email System may maintain a database of the email addresses and domains serviced by the Confirming Email System and may refer to this database in order to determine whether to make a Confirmation Request of the Confirming Email System or of the Sending Email System hosting the domain name of the purported sender. Further, where there is a plurality of Confirming Email Systems operating in a communications network, the database maintained by the Receiving Email System may identify the specific Confirming Email System performing confirmation functions for the purported sender. Alternatively, a consolidated Centralized Serviced Name Registry may provide a comprehensive database identifying the specific Confirming Email System for purported senders.

While the invention has been described in reference to certain preferred embodiments, it will be readily apparent to one of ordinary skill in the art that certain modifications or variations may be made to the system without departing from the scope of invention claimed below and described in the foregoing specification.

### INDUSTRIAL APPLICABILITY

The invention may be used, in varying capacities, by both corporate and private entitles for the verification of delivery of electronic messages and for the collection of data facilitating the early detection of phishing attempts, as well as the source of phish attempts and the identification of phishers. Users may implement the invention, and potentially incorporate one or more of its features, into their existing information technology infrastructure. By virtue of the invention's use, electronic mail operation would become more efficient and reliable, spam and phishing may be reduced or eliminated, and electronic mail communications between parties would be more secure.

I claim:

1. A method for verifying the delivery of an electronic message in a network comprising at least one sending device sending electronic messages and at least one receiving device receiving electronic messages wherein each said electronic message sent by said sending device contains data identifying each said electronic message sent and wherein each said electronic message sent by said sending device contains data identifying the sending device purportedly sending each said electronic message, the method comprising the steps of:
preparing, by said sending device, an information record for each said electronic message sent by said sending device wherein each said information record contains data identifying each said electronic message sent by said sending device;
storing each said information record prepared by said sending device;
transmitting, by said sending device, an electronic message to said receiving device;
receiving, by said receiving device, an electronic message sent by said sending device;
withholding the delivery to the intended recipient of said electronic message received by said receiving device;
locating, by said receiving device, within said received electronic message device, data identifying said received electronic message and data identifying said sending device from which the received electronic message is purported to have been sent, wherein said data identifying said received electronic message corresponds to said data identifying each electronic message sent by said sending device and stored by said sending device in an information record;
preparing, by said receiving device, a confirmation request wherein said confirmation request contains data identifying said received electronic message wherein said data identifying said received electronic message corresponds to data identifying each electronic message sent by said sending device and stored by said sending device in an information record;
transmitting, by said receiving device, said confirmation request to said sending device purported to have been the sender of said received electronic message;
receiving, by said sending device, said confirmation request wherein said confirmation request contains data identifying a received electronic message by said receiving device and wherein said data identifying a received electronic message corresponds to data identifying an electronic message sent by said sending device and stored in an information record;
comparing by said sending device, data identifying said received electronic message with data in each said information record to determine whether said received electronic message was sent by said sending device;
replying, by said sending device, to said confirmation request, wherein said reply affirms that said received electronic message was sent by said sending device when said data identifying said received electronic message identifies an electronic message sent by said sending device;
appending by said sending device to said information record for said received electronic message data related to said reply.
receiving, by said receiving device, a reply to said confirmation request, and;
making available for delivery, said received electronic message to said intended recipient when said reply to said confirmation request affirms that said sending device sent said received electronic message.

2. The method of claim 1 wherein said data related to said reply appended to said information record comprises the date and time said reply was transmitted.

3. The method of claim 2 wherein said data related to said reply appended to said information record further comprises the address to which said reply was transmitted.

4. The method of claim 1 wherein the data identifying each said electronic message sent by said sending device comprises the date and time the electronic message was prepared and the electronic address for the purported sender of each said sent electronic message and wherein said data identifying each said received electronic message received by said receiving device comprises the date and time said electronic message was prepared and the electronic address for the purported sender of said received electronic message.

5. The method of claim 4 wherein said data related to said reply appended to said information record comprises the date and time said reply was transmitted.

6. the method of claim 5 wherein said data related to said reply appended to said information record further comprises the address to which said reply was transmitted.

7. The method of claim 1 wherein the step of transmitting a confirmation request by said receiving device further includes encrypting said confirmation request, the step of receiving said confirmation request by said sending device further includes decrypting said confirmation request, the step of replying to said confirmation request by said sending device further includes encrypting said reply, and the step of receiving said reply by said receiving device further includes decrypting said reply.

8. The method of claim 7 wherein said data related to said reply appended to said information record comprises the date and time said reply was transmitted.

9. The method of claim 8 wherein said data related to said reply appended to said information record further comprises the address to which said reply was transmitted.

10. A method for verifying the delivery of an electronic message in a network comprising at least one sending device sending electronic messages, at least one receiving device receiving electronic messages and at least one confirming device, confirming the authenticity of electronic messages sent by at least one sending device, wherein each said electronic message sent by said sending device contains data identifying each said electronic message sent and wherein each said electronic message sent by said sending device contains data identifying the sending device purportedly sending each said electronic message, the method comprising the steps of:
transmitting to said confirming device by said sending device, data identifying each said electronic message sent by said sending device,
preparing, by said confirming device, an information record for each said electronic message sent by said sending device wherein each said information record contains data identifying each said electronic message sent by said sending device;
storing said information records by said confirming device;
transmitting, by said sending device, an electronic message to said receiving device;
receiving, by said receiving device, an electronic message sent by said sending device;
withholding the delivery to the intended recipient of said electronic message received by said receiving device;
locating, by said receiving device, within said received electronic message device, data identifying said received electronic message and data identifying said sending device from which the received electronic message is purported to have been sent, wherein said data identifying said received electronic message corresponds to said data identifying each electronic message sent by said sending device and stored by said confirming device in an information record;
preparing by said receiving device, a confirmation request wherein said confirmation request contains data identifying said received electronic message wherein said data identifying said received electronic message corresponds to data identifying each electronic message sent by said sending device and stored by said confirming device in an information record and wherein said confirmation request contains data identifying said sending device from which the received electronic message is purported to have been sent;
transmitting, by said receiving device, said confirmation request to said confirming device;
receiving, by said confirming device, said confirmation request wherein said confirmation request contains data identifying an electronic message received by said receiving device and wherein said data identifying said received electronic message corresponds to data identifying an electronic message sent by said sending device and stored by said confirming device in an information record and wherein said confirmation request contains data identifying said sending device from which the received electronic message is purported to have been sent;
comparing, by said confirming device, data identifying said received electronic message with data in each said information record for said sending device purported to have sent said received electronic message to determine whether said received electronic message was transmitted by said sending device;
replying, by said confirming device, to said confirmation request, wherein said reply affirms that said received electronic message was sent by said sending device when said data identifying said received electronic message identifies an electronic message sent by said sending device;
appending by said confirming device to said information record for said received electronic message data related to said reply. receiving, by said receiving device, a reply to said confirmation request, and;
making available for delivery, said received electronic message to said intended recipient when said reply to said confirmation request affirms that said sending device sent said received electronic message.

11. The method of claim 10 wherein said data related to said reply appended to said information record comprises the date and time said reply was transmitted.

12. The method of claim 11 wherein said data related to said reply appended to said information record further comprises the address to which said reply was transmitted.

13. The method of claim 10 wherein the data identifying each said electronic message sent by said sending device comprises the date and time the electronic message was prepared and the electronic address for the purported sender of each said sent electronic message and wherein said data identifying each said received electronic message received by said receiving device comprises the date and time said electronic message was prepared and the electronic address for the purported sender of said received electronic message.

14. The method of claim 13 wherein said data related to said reply appended to said information record comprises the date and time said reply was transmitted.

15. The method of claim 14 wherein said data related to said reply appended to said information record further comprises the address to which said reply was transmitted.

16. The method of claim 10 wherein the step of transmitting a confirmation request by said receiving device further includes encrypting said confirmation request, the step of receiving said confirmation request by said confirming device further includes decrypting said confirmation request, the step of replying to said confirmation request by said confirming device further includes encrypting said reply, and the step of receiving said reply by said receiving device further includes decrypting said reply.

17. The method of claim 16 wherein said data related to said reply appended to said information record comprises the date and time said reply was transmitted.

18. The method of claim 17 where said data related to said reply appended to said information record further comprises the address to which said reply was transmitted.

19. A method for preventing the delivery of unsolicited and undesired electronic messages within a network comprising at least one sending device sending electronic messages and at least one receiving device receiving electronic messages wherein at least one electronic message sent by at least one sending device contains a key that has been generated by application of an algorithm to at least one data element of the electronic message and wherein said electronic message sent by at least one sending device in said network contains data identifying the sending device sending each said electronic message, and wherein, by pre-arrangement within said network said data elements from which said key is generated by said sending device is known by at least one receiving device, the method comprising the steps of:
generating, by said sending device, and by the application of an algorithm to said data elements in an electronic message to be sent by said sending device, a key;
incorporating, by said sending device, said key with said electronic message to be sent by said sending device;
transmitting, by said sending device, said electronic message to said receiving device;
receiving, by said receiving device, an electronic message purportedly sent by said sending device;
withholding delivery to the intended recipient of said electronic message received by said receiving device;
locating, by said receiving device, within said received electronic message, a key for said received electronic message and said data elements from which, by pre-arrangement within the communication system, said key for said received electronic message would have been generated by said sending device purported to have sent said electronic message;
preparing, by said receiving device, a confirmation request wherein said confirmation request contains said key from said received electronic message and said data elements from which, by pre-arrangement within the communication system, said key would have been generated by said sending device purported to have sent said electronic message;
transmitting, by said receiving device, said confirmation request to said sending device purported to have been the sender of said received electronic message;
receiving, by said sending device, said confirmation request;
generating a comparison key, by said sending device and by applying the algorithm said sending device would have applied to generate a key had said sending device sent said received electronic message, and by applying said algorithm to said data elements in said confirmation request;
comparing, by said sending device, the comparison key with the key from said received electronic message contained in said confirmation request;
replying, by said sending device, to said confirmation request, wherein said reply affirms that said received electronic message was sent by said sending device when said comparison key is identical to said key from said received electronic message contained in the confirmation request;
preparing, by said sending device, a data record containing data related to said reply sent by said sending device;
receiving, by said receiving device, a reply to said confirmation request;
making available for delivery , by said receiving device, said received electronic message to said intended recipient when said reply to said confirmation request affirms that said sending device sent said received electronic message.

20. The method of claim 19 wherein said data related to said reply appended to said information record comprises the date and time said reply was transmitted.

21. The method of claim 20 wherein the data appended to said information record further comprises the address to which said reply was transmitted.

22. A method for collecting data related to electronic messages forwarded with false origination addresses in a network comprising at least one sending device sending electronic messages and at least one receiving device receiving electronic messages wherein each said electronic message sent by said sending device contains data identifying each said electronic message sent and wherein each said electronic message sent by said sending device contains data identifying the sending device purportedly sending each said electronic message, the method comprising the steps of:
preparing, by said sending device, an information record for each said electronic message sent by said sending device wherein each said information record contains data identifying each said electronic message sent by said sending device;
storing each said information record prepared by said sending device;
transmitting, by said sending device, an electronic message to said receiving device;
receiving, by said receiving device, an electronic message sent by said sending device;
withholding the delivery to the intended recipient of said electronic message received by said receiving device;
locating, by said receiving device, within said received electronic message device, data identifying said received electronic message and data identifying said sending device from which the received electronic message is purported to have been sent, wherein said data identifying said received electronic message corresponds to said data identifying each electronic message sent by said sending device and stored by said sending device in an information record;
preparing, by said receiving device, a confirmation request wherein said confirmation request contains data identifying said received electronic message wherein said data identifying said received electronic message corresponds to data identifying each electronic message sent by said sending device and stored by said sending device in an information record;
transmitting, by said receiving device, said confirmation request to said sending device purported to have been the sender of said received electronic message;
receiving, by said sending device, said confirmation request wherein said confirmation request contains data identifying a received electronic message by said receiving device and wherein said data identifying a received electronic message corresponds to data identifying an electronic message sent by said sending device and stored in an information record;
comparing, by said sending device, data identifying said received electronic message with data in each said information record to determine whether said received electronic message was sent by said sending device;
replying, by said sending device, to said confirmation request, wherein said reply denies that said received electronic message was sent by said sending device when said data identifying said received electronic message does not identify an electronic message sent by said sending device and wherein said reply requests that said receiving device forward data related to said received electronic message;
receiving, by said receiving device, said reply to said confirmation request, and;
transmitting to said sending device data related to said received electronic message.

23. The method of claim 22 wherein said data related to said received electronic message comprises the date and time said received electronic message was transmitted, the address of the intended recipients of said received electronic message and the address for each devices sending or forwarding said received electronic message.

24. The method of claim 22 wherein said data related to said received electronic message comprises said received electronic message.

25. The method of claim 22 wherein the data identifying each said electronic message sent by said sending device comprises the date and time the electronic message was prepared and the electronic address for the purported sender of each said sent electronic message and wherein said data identifying each said received electronic message received by said receiving device comprises the date and time said electronic message was prepared and the electronic address for the purported sender of said received electronic message.

26. The method of claim 25 wherein said data related to said received electronic message comprises the date and time said received electronic message was transmitted, the address of the intended recipients of said received electronic message and the address for each device sending or forwarding said received electronic message.

27. The method of claim 25 wherein said data related to said received electronic message comprises said received electronic message.

28. The method of claim 22 wherein the step of transmitting a confirmation request by said receiving device further includes encrypting said confirmation request, the step of receiving said confirmation request by said sending device further includes decrypting said confirmation request, the step of replying to said confirmation request by said sending device further includes encrypting said reply, and the step of receiving said reply by said receiving device further includes decrypting said reply.

29. The method of claim 28 wherein said data related to said received electronic message comprises the date and time said received electronic message was transmitted, the address of the intended recipients of said received electronic message and the address for each device sending or forwarding said received electronic message.

30. The method of claim 28 wherein said data related to said received electronic message comprises said received electronic message.

31. A method for collecting data related to electronic messages forwarded with false origination addresses in a network comprising at least one sending device sending electronic messages, at least one receiving device receiving electronic messages and at least one confirming device, confirming the authenticity of electronic messages sent by at least one sending device, wherein each said electronic message sent by said sending device contains data identifying each said electronic message sent and wherein each said electronic message sent by said sending device contains data identifying the sending device purportedly sending each said electronic message, the method comprising the steps of:
transmitting to said confirming device by said sending device, data identifying each said electronic message sent by said sending device,
preparing, by said confirming device, an information record for each said electronic message sent by said sending device wherein each said information record contains data identifying each said electronic message sent by said sending device;
storing said information records by said confirming device;
transmitting by said sending device, an electronic message to said receiving device;
receiving, by said receiving device, an electronic message sent by said sending device;
withholding the delivery to the intended recipient of said electronic message received by said receiving device;
locating, by said receiving device, within said received electronic message device, data identifying said received electronic message and data identifying said sending device from which the received electronic message is purported to have been sent, wherein said data identifying said received electronic message corresponds to said data identifying each electronic message sent by said sending device and stored by said confirming device in an information record;
preparing, by said receiving device, a confirmation request wherein said confirmation request contains data identifying said received electronic message wherein said data identifying said received electronic message corresponds to data identifying each electronic message sent by said sending device and stored by said confirming device in an information record and wherein said confirmation request contains data identifying said sending device from which the received electronic message is purported to have been sent;
transmitting, by said receiving device, said confirmation request to said confirming device;
receiving, by said confirming device, said confirmation request wherein said confirmation request contains data identifying an electronic message received by said receiving device and wherein said data identifying said received electronic message corresponds to data identifying an electronic message sent by said sending device and stored by said confirming device in an information record and wherein said confirmation request contains data identifying said sending device from which the received electronic message is purported to have been sent;
comparing, by said confirming device, data identifying said received electronic message with data in each said information record for said sending device purported to have sent said received electronic message to determine whether said received electronic message was transmitted by said sending device;
replying, by said confirming device, to said confirmation request, wherein said reply denies that said received electronic message was sent by said sending device when said data identifying said received electronic message does not identify an electronic message sent by said sending device and wherein said reply requests that said receiving device forward data related to said received electronic message;
receiving, by said receiving device, said reply to said confirmation request, and;
transmitting to said sending device data related to said received electronic message.

32. The method of claim 31 wherein said data related to said received electronic message comprises the date and time said received electronic message was transmitted, the address of the intended recipients of said received electronic message and the address for each device sending or forwarding said received electronic message.

33. The method of claim 31 wherein said data related to said received electronic message comprises said received electronic message.

34. The method of claim 31 wherein the data identifying each said electronic message sent by said sending device comprises the date and time the electronic message was prepared and the electronic address for the purported sender of each said sent electronic message and wherein said data identifying each said received electronic message received by said receiving device comprises the date and time said electronic message was prepared and the electronic address for the purported sender of said received electronic message.

35. The method of claim 34 wherein said data related to said received electronic message comprises the date and time said received electronic message was transmitted, the address of the intended recipients of said received electronic message and the address for each device sending or forwarding said received electronic message.

36. The method of claim 34 wherein said data related to said received electronic message comprises said received electronic message.

37. The method of claim 34 wherein the step of transmitting a confirmation request by said receiving device further includes encrypting said confirmation request, the step of receiving said confirmation request by said confirming device further includes decrypting said confirmation request, the step of replying to said confirmation request by said confirming device further includes encrypting said reply, and the step of receiving said reply by said receiving device further includes decrypting said reply.

38. The method of claim 37 wherein said data related to said received electronic message comprises the date and time said received electronic message was transmitted, the address of the intended recipients of said received electronic message and the address for each device sending or forwarding said received electronic message.

39. The method of claim 37 wherein said data related to said received electronic message comprises said received electronic message.

40. A method for collecting data related to electronic messages forwarded with false origination addresses within a network comprising at least one sending device sending electronic messages and at least one receiving device receiving electronic messages wherein at least one electronic message sent by at least one sending device contains a key that has been generated by application of an algorithm to at least one data element of the electronic message and wherein said electronic message sent by at least one sending device in said network contains data identifying the sending device sending each said electronic message, and wherein, by pre-arrangement within said network said data elements from which said key is generated by said sending device is known by at least one receiving device, the method comprising the steps of:
generating, by said sending device, and by the application of an algorithm to said data elements in an electronic message to be sent by said sending device, a key;
incorporating, by said sending device, said key with said electronic message to be sent by said sending device;
transmitting, by said sending device, said electronic message to said receiving device;
receiving, by said receiving device, an electronic message purportedly sent by said sending device;
withholding delivery to the intended recipient of said electronic message received by said receiving device;
locating, by said receiving device, within said received electronic message, a key for said received electronic message and said data elements from which, by pre-arrangement within the communication system, said key for said received electronic message would have been generated by said sending device purported to have sent said electronic message;
preparing, by said receiving device, a confirmation request wherein said confirmation request contains said key from said received electronic message and said data elements from which, by pre-arrangement within the communication system, said key would have been generated by said sending device purported to have sent said electronic message;
transmitting, by said receiving device, said confirmation request to said sending device purported to have been the sender of said received electronic message;
receiving, by said sending device, said confirmation request;
generating a comparison key, by said sending device and by applying the algorithm said sending device would have applied to generate a key had said sending device sent said received electronic message, and by applying said algorithm to said data elements in said confirmation request;
comparing, by said sending device, the comparison key with the key from said received electronic message contained in said confirmation request;
replying, by said sending device, to said confirmation request, wherein said reply denies that said received electronic message was sent by said sending device when said comparison key is not identical to said key from said received electronic message contained in the confirmation request and wherein said reply requests that said receiving device transmit data related to said received electronic message to said sending device;
receiving, by said receiving device, a reply to said confirmation request;
transmitting, by said receiving device, data related to said received electronic message to said sending device.

41. The method of claim 40 wherein said data related to said received electronic message comprises the date and time said received electronic message was transmitted, the address of the intended recipients of said received electronic message and the address for each device sending or forwarding said received electronic message.

42. The method of claim 40 wherein said data related to said received electronic message comprises said received electronic message.
